(19) United States
(12) Patent Application Publication
(10) Pub. No.: US 2012/0131197 A1
(43) Pub. Date: May 24, 2012

(54) METHOD AND APPARATUS FOR AUTOMATICALLY RESOLVING CONFLICTING DEVICES ON A NETWORK

(75) Inventors: Mark Prentice, Belfast (GB); Yannick Tremblay, Carrickfergus (GB)

(73) Assignee: SENSORMATIC ELECTRONICS, LLC, Boca Raton, FL (US)

(21) Appl. No.: 13/164,805

(22) Filed: Jun. 21, 2011

Related U.S. Application Data
(60) Provisional application No. 61/416,378, filed on Nov. 23, 2010.

(51) Int. Cl. G06F 15/16

(52) U.S. Cl. 709/226

(57) ABSTRACT

A method and apparatus are disclosed for automatically detecting and resolving conflicts between devices on a security network by comparing the IP addresses of all devices on the network. When one or more conflicts are detected, the user is presented with the option of reassigning the conflicting device to a DHCP address, or to a new static IP address. The new static IP address can be configured to lie within a user defined range. In one embodiment, a default changes the address to any free address on the network. The disclosed method and apparatus automates the conflict resolution process without requiring that network devices (e.g., cameras, camera encoders) be individually and sequentially connected to the security network in order to resolve conflicts. The disclosed approach results in reduced human interaction and is much faster than the traditional approach of adding devices one at a time to the network. Other embodiments are also disclosed.

### CROSS-REFERENCE TO RELATED APPLICATIONS

This is a non-provisional of pending U.S. Provisional Patent Application Ser. No. 61/416,378, filed Nov. 23, 2010, the entirety of which application is incorporated by reference herein.

### BACKGROUND OF THE INVENTION

1. Field of the Invention

Embodiments of the invention generally relate to the field of security systems, and more particularly to a method and apparatus for automatically resolving conflicting IP addresses for a plurality of security system components in a network.

2. Discussion of Related Art

Security systems often include a variety of observation, detection and/or alarm devices connected via a network. Each device in the network may have an Internet Protocol address (IP address), which is a numerical label that serves to identify the device and to indicate its location on the network.

When IP devices (e.g., video cameras, video encoders, and the like) are initially added to a security system network, they may either default to use Dynamic Host Configuration Protocol (DHCP) or, failing that (for example, due to camera default or lack of an available DHCP server), they may default to a static IP address. A detailed description of the DHCP can be found in Network Working Group Request for Comments 2132 “DHCP Options and BOOTP Vendor Extensions,” the entirety of which is incorporated herein by reference. A static IP address is often the factory default address and it can be the same for all devices in a particular product line, and possibly all devices from a particular vendor. As will be appreciated, this can cause a problem when installing multiple devices on a network that uses static IP addressing because many of the devices will be identified by the same static IP address. Such conflicts need to be resolved before normal operation of the devices on the network is possible. Currently, conflicts are resolved by manually configuring the devices on an individual basis.

To perform individual configuration, device IP addresses are changed by sending commands to the devices via transmission control protocol/internet protocol (TCP/IP). This technique is a point to point process and if multiple devices are initially identified by the same IP address only one of those devices will receive the request. Moreover, there is no way of knowing which device received the request. Further, when different mechanisms are used to communicate with system devices, there is a high probability that the device that receives the request may not understand it, or may be listening on a different port. Therefore, inherent problems exist with current techniques that aim to change the IP address of a particular device when that device is in conflict with other devices.

When reassigning IP addresses for network devices, prior techniques have included suggesting to the user one or more IP addresses that might be free so that the user will not inadvertently assign an IP address that is already assigned to another device. Such techniques, however, are applicable on an individual basis only, and do not take into account potential conflicts, nor are they capable of routing commands to the correct (i.e., targeted) device in a conflicted scenario as described above. Adding devices one at a time to the network and manually changing the IP address before adding the next device is one solution. Alternatively, a DHCP server can be used to allocate IP addresses among devices, thus avoiding conflicts, but this does not address the problem of devices that are conflicting on a static network (i.e., there is no DHCP server on the network), or where the network has a DHCP server but the devices cannot communicate with it.

As will be appreciated, adding devices one at a time and manually configuring them to a new IP address is time-consuming and manpower intensive. There is a need, therefore, for an improved method and apparatus for automatically assigning IP addresses to security system devices on a static security system network.

### SUMMARY OF THE INVENTION

A method is disclosed for resolving conflicts in IP addresses for a plurality of devices on a network. The method includes: identifying at least first and second devices associated with a network as having a same IP address; determining a first IP address in an IP address range as being free for allocation to one of the first and second devices; adding an entry to an address resolution protocol (ARP) table to route TCP/IP commands to the first or second device; correlating an original IP address of the first or second to a media access control (MAC) address of that device; sending a command to change the IP address of the first or second device to the first IP address; and reclassifying the first IP address as no longer being free for allocation by clearing the entry in the ARP table.

A system is also disclosed for resolving conflicts in IP addresses for a plurality of devices on a network. The system can include a processor and a memory, a plurality of IP addressable devices, and a machine-readable storage medium encoded with a computer program code such that, when the computer program code is executed by a processor, the processor performs a method. The method can include: identifying at least first and second devices associated with a network as having a same IP address; determining a first IP address in an IP address range as being free for allocation to one of the first and second devices; adding an entry to an address resolution protocol (ARP) table to route TCP/IP commands to the first or second device; correlating an original IP address of the first or second to a media access control (MAC) address of that device; sending a command to change the IP address of the first or second device to the first IP address; and reclassifying the first IP address as no longer being free for allocation before clearing the entry in the ARP table.

### BRIEF DESCRIPTION OF THE DRAWINGS

The accompanying drawing illustrates an exemplary embodiment of the disclosed method and system so far devised for the practical application of the principles thereof, and in which:

FIG. 1 is a schematic diagram of the disclosed system;

FIG. 2 is a flowchart describing an exemplary method of operating the system of FIG. 1; and

FIG. 3 is an exemplary screen shot showing a listing of conflicting devices, and offering a user the option of how to resolve the conflicts.

### DESCRIPTION OF EMBODIMENTS

The present invention will now be described more fully hereinafter with reference to the accompanying drawings, in which preferred embodiments of the invention are shown. It will be appreciated, however, that the invention may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

As used herein, relational terms, such as “first” and “second,” “top” and “bottom,” and the like, may be used solely to distinguish one entity or element from another entity or element without necessarily requiring or implying any physical or logical relationship or order between such entities or elements.

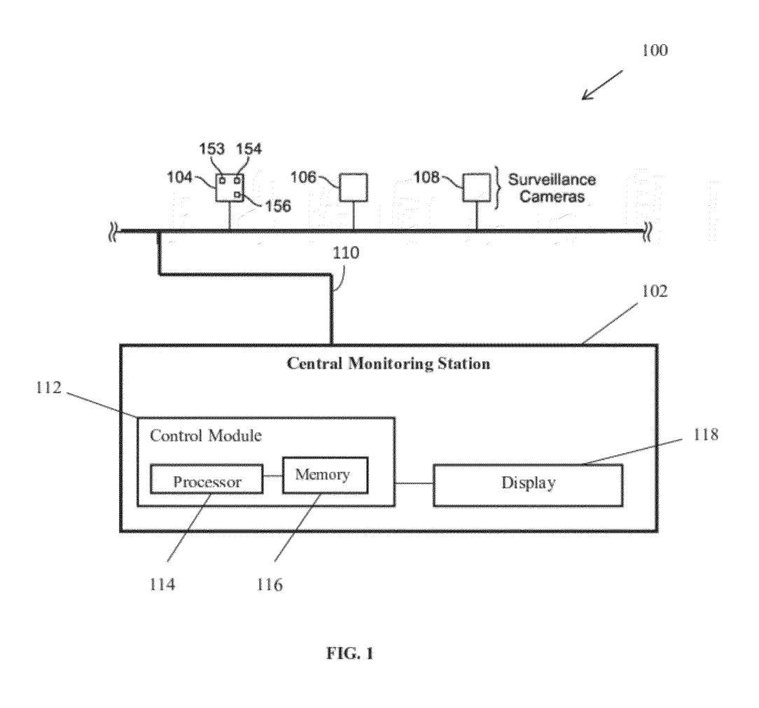

FIG. 1 illustrates a security system 100 which has a central monitoring station 102 for monitoring and/or controlling devices installed on a network 110. The devices may detect and/or monitor locations and movement of people, animals and machines or may accomplish other security functions as desired. For example, the system 100 may be used within a light industrial building or a residence, as well as larger facilities.

The system 100 can have one or more surveillance camera, such as first camera 104, second camera 106 through N^{th} camera 108. Each of the first through N^{th} video cameras 104-108 may have components such as a processor 153 and memory 154 to enable communication with the central monitoring station 102 over the network 110. As each security system 100 may be configured differently, it should be understood that each camera 104-108 may be positioned to image an area or region of interest associated with one or more sensors and/or detectors. In addition, although the description of system 100 will proceed in relation to set-up and control of a plurality of video cameras, it will be appreciated that the system 100 can also (or alternately) include a variety of other surveillance, detection and alarm devices such as motion sensors, broken glass sensors, door opening and closing sensors, fire and smoke detectors, and the like. In some embodiments, the detection and alarm devices may be used to detect triggering events which activate at least one of the first through N^{th} cameras 104-108.

The network 110 may be configured to carry power and communications to the cameras 104-108, which may be individually addressable devices, from the central monitoring station 102. The network 110 may comprise a single logical entity, or it may include one or more logical sub-nets. The cameras 104-108 may each have a unique address on the network 110 (or sub-net) and can send and receive communications to and from the system control panel 102.

The central monitoring station 102 may include a control module 112 which may include a processor 114 and associated memory 116. Operating code may be provided on a hard disk, ROM, flash memory, stored and run on a CPU card, or other non-transitory storage media or memory, such as non-volatile memory 116. The central monitoring station 102 may include a display 118 for providing a visual display of information received from the cameras 104-108. The display 118 may also be used provide a user with information relating to conflicting devices on the network, and to facilitate user interaction with the system 100 to resolve such conflicts.

As noted, where a plurality of devices, such as cameras 104-108, exist on a security system network 110 it is desirable to provide each of those devices with a unique network address so that conflict-free communications with the devices can be accomplished during system operation. Thus, an embodiment of the present disclosure automatically detects conflicts between network devices by comparing the IP addresses of all devices found on a particular network. When one or more conflicts are detected, the system implements a “Resolve Conflicts” functionality that allows a user to reassign the IP addresses of all conflicting devices. The user may have the option of reassigning the device to a DHCP address, or to a new static IP address in a range that is selectable by the user.

In one embodiment, the new static IP address can be configured to lie within a user-defined range on a logical subdivision of the system network (i.e., a sub-net), or within a range on a new sub-net, as desired by the user. Alternatively, a default may be provided that assigns the device to any free address on an existing sub-net.

The system 100 may employ a device discovery process to determine what devices exist on the network 110. This may include an active discovery process or a passive discovery process. With the active discovery process two different “Probe” and “Response” mechanisms are employed. In this mode, the system broadcasts a “Probe” message. All devices that receive this message are requested to respond with a “Response” message. The “Response” message contains information about the Media Access Control (MAC) address and current IP address of the newly discovered device. With the passive discovery process the system constantly listens for broadcasted “hello” messages using a standard protocol. When devices are connected to the network and powered on, they broadcast a “hello” message on the network. This “hello” message contains information about the MAC address and current IP address of newly connected devices.

Thus, using one of the above techniques, the MAC address is obtained for all devices that have been discovered regardless of whether or not such devices are in conflict. The MAC address is a unique identifier (often referred to as the burned-in address of the device) that is assigned to network devices for communications on a physical network or sub-net. It may also be known as an Ethernet hardware address (EHA), hardware address or physical address.

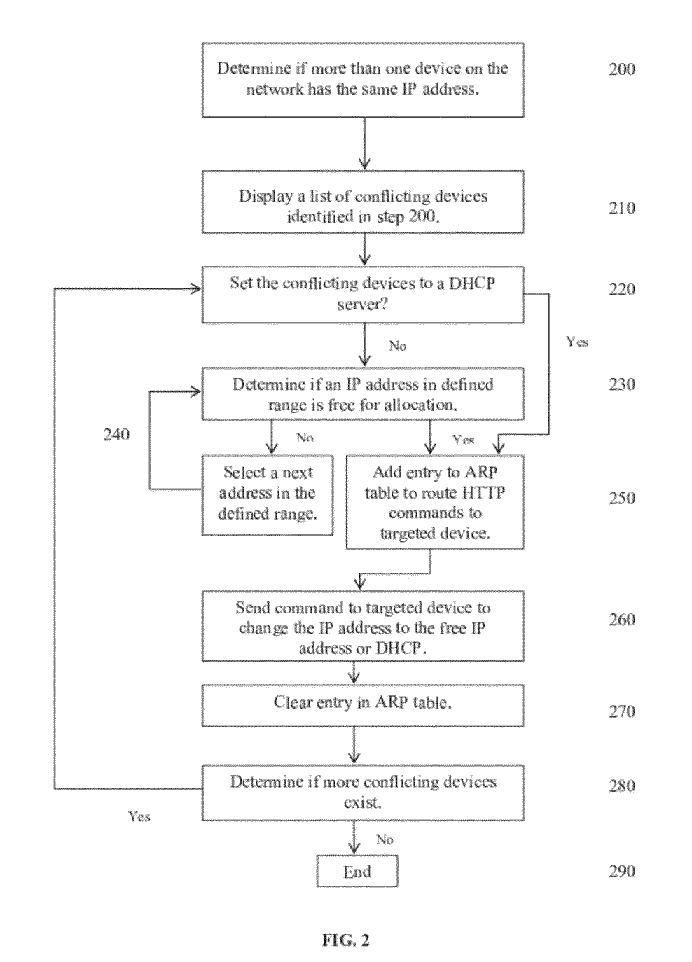

Referring to FIG. 2, a method of operating the system 100 of FIG. 1 will now be described. Initially, the system 100 performs a check to determine whether there are any devices on the network that have conflicting (i.e., the same) IP addresses (step 200). In some embodiments, a discovery scan (i.e., the previously described active discovery process) is performed and creates a list of devices that respond to a discovery broadcast issued from the central monitoring station 102. A list of conflicting devices may then be displayed to the user via display 118 (step 210). In some embodiments, this list of conflicting devices may also include a list of devices that are known to reside on the network 110. This may be useful where new devices are being added to a network that includes one or more existing devices. The display may include a list of conflicting devices including device name, associated IP address, device model, hostname, manufacturer, firmware version, and device MAC. At step 220, the user may elect to set all conflicting devices to an existing or new DHCP server or to perform a static IP address reallocation. If the user elects to set the conflicting devices to a DHCP server, then all selected conflicting devices will be reconfigured to use DHCP. Alternatively, if the user elects to perform a static IP address reallocation, at step 230 a check is performed to determine whether the first IP address in a defined range (e.g., 192.160.0.1 to 192.160.0.254) is free for allocation (i.e., the address is not already allocated to a device). In some embodiments, the defined range is specified by the user, while in other embodiments, the range may be a default range such as the range of addresses assigned to the associated existing network or sub-net. The check of step 230 is performed by comparing a first address in the range against an internal list of addresses assigned to devices known to be present on the network, and by verifying that the first address is free using a mechanism such as a ping or a portmap. In one embodiment, Internet Control Message Protocol (ICMP) echo request packets are sent to the target address. If no response is provided, the address is determined to be free. The internal list may be obtained using a broadcast request, a ping, or using a known number obtained for a particular device from factory information. If the first address in the range is determined to be unavailable, (i.e., an existing device on the network or sub-net is already assigned that IP address), at step 240 a next address in the user-specified range is selected and the check is re-performed to verify that the next address is available. This step continues until a free address is identified at step 230.

When a free address has been identified, at step 250 an entry is added to the Address Resolution Protocol table (ARP table) of the control module 112 that will route the TCP/IP commands to a targeted device (i.e., the device that will have its address reassigned). In one non-limiting exemplary embodiment, the TCP/IP commands are hypertext transfer protocol (HTTP) commands. The ARP table entry maps an original conflicting IP address of the targeted device to the MAC address of the targeted device. (As previously noted, a “conflicting IP address” is a single address associated with more than one device on the network, and may be the IP address assigned to the targeted device before it is reassigned to a free IP address.) A description of the ARP can be found in Network Working Group Request for Comments 826 “An Ethernet Address Resolution Protocol,” the entirety of which is incorporated herein by reference.

The entry is added to the ARP table using a command appropriate to the controller's operating system. For example, an ARP command may be used for Windows XP, a network shell (Netsh) command may be used for Windows Vista or Windows 7. Other appropriate commands may be used depending upon the operating system.

At step 260, a command for changing the networking configuration of the targeted device is sent from the controller 102 to the device. The command may change the IP address of the targeted device to the free IP address or to DHCP. At step 270 the entry in the ARP table that maps the conflicting IP address to the MAC address of the targeted device is cleared, thus allowing another conflicting device to be mapped to the conflicting IP address.

At step 280, a determination is made whether additional devices exist in the list of devices to be cleared of conflicting IP addresses (i.e., whether more conflicting devices exist). If no additional devices exist in the list of devices, then at step 290 the procedure ends. If, however, one or more additional devices remain in the list, steps 220-280 are repeated for each device remaining in the list, provided there are enough free IP addresses in the range specified by the user.

If the system 100 determines that there are not enough free IP addresses in the specified range, the system may provide an indication to the user that it has run out of free addresses. The user may then be prompted to enlarge or otherwise change the range by a pop-up window provided in the user interface, whereupon the conflict resolution process can be re-run or re-started.

If the user elects to manually configure a device that is known to be in conflict, the disclosed method and apparatus may add an entry in the ARP table to ensure the configuration commands are routed to the correct device. This automatic addition (and removal) in the ARP table is carried out without further user action.

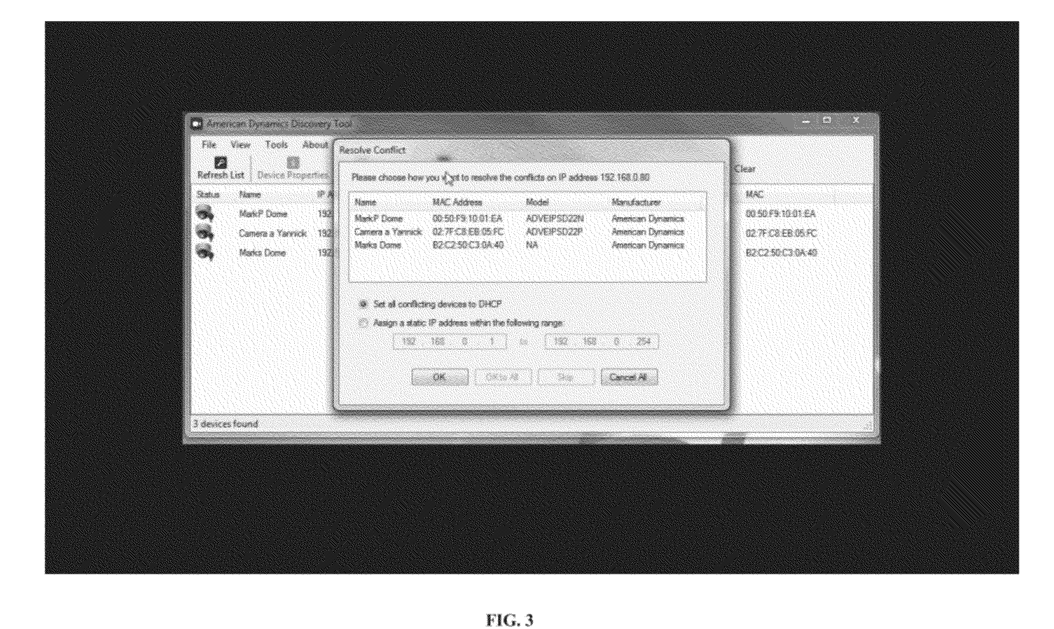

Thus described, the disclosed method and apparatus automatically detects and resolves conflicts by comparing the IP addresses of all devices found on a security system network. When one or more conflicts are detected, the user is presented with the option of reassigning the conflicting device to a DHCP address, or to a new static IP address. FIG. 3 shows an exemplary screen shot in which the user is presented with such an option. As can be seen, the resolution method is selectable by simply clicking on the appropriate box in the pop-up window. The new static IP address can be configured to lie within a user-defined range on an existing subnet, or within a particular range on a new subnet, as desired by the user. In one embodiment, a default changes the address to any free address on the current subnet.

The disclosed method and apparatus automates the conflict resolution process without requiring that network devices (e.g., cameras, camera encoders) be individually and sequentially connected to the security network in order to resolve conflicts. The disclosed approach results in reduced human interaction and is much faster than the traditional approach of adding devices one at a time to the network.

It will be appreciated that the disclosed method and apparatus are not limited to use only in security system networks, nor are they limited to use with particular types of components (e.g., cameras) used in security system network applications. Rather, the disclosed method and apparatus will find broad application in a wide variety of network and network component applications (e.g., recording devices and the like). The method and apparatus can be applied to any network device that can be configured/reconfigured using TCP/IP. Further, the disclosed method and apparatus can be used to resolve conflicts for any IP device that can be configured via TCP/IP commands, where its IP address and MAC address can be obtained during the discovery process.

The systems and processes of FIGS. 1 and 2 are not exclusive, and other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The processes and applications may, in alternative embodiments, be located on one or more (e.g., distributed) processing devices accessing a network linking the elements of FIG. 1. Further, any of the functions and steps provided in FIG. 2 may be implemented in hardware, software or a combination of both and may reside on one or more processing devices located at any location of a network linking the elements of FIG. 1 or another linked network, including the Internet.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A method for resolving conflicts in IP addresses for a plurality of devices on a network, comprising:
identifying at least first and second devices associated with a network as having a same IP address;
determining a first IP address in an IP address range as being free for allocation to one of the first and second devices;
adding an entry to an address resolution protocol (ARP) table to route TCP/IP commands to the first or second device;
correlating an original IP address of the first or second to a media access control (MAC) address of that device;
sending a command to change the IP address of the first or second device to the first IP address;
reclassifying the first IP address as no longer being free for allocation; and
clearing the entry in the ARP table so that so that TCP/IP commands can be routed to other conflicting devices.

2. The method of claim 1, wherein the determining step comprises checking the first IP address against a list of IP addresses of devices known to be present on the network.

3. The method of claim 1, comprising verifying that the first address is free using a network scanning mechanism.

4. The method of claim 3, wherein the network scanning mechanism comprises a ping or a portmap.

5. The method of claim 1, wherein at least one of the plurality of devices comprises a video camera.

6. The method of claim 1, wherein when the first IP address is determined to be unavailable, selecting a next IP address and determining whether the next IP address is free for allocation.

7. The method of claim 1, wherein the IP address range is user-defined.

8. The method of claim 7, wherein the command to change the IP address of the first or second device comprises a TCP/IP command.

9. The method of claim 1, comprising determining whether a second targeted device is listed in a list of devices to be cleared of conflicting IP addresses; and repeating said determining, adding, correlating, sending and reclassifying steps for the second targeted device.

10. The method of claim 1, wherein if the first IP address is determined to be not free, determining whether a next IP address is free.

11. The method of claim 10, comprising repeating the determining step until a free address is identified.

12. A system for resolving conflicts in IP addresses for a plurality of devices on a network, the system comprising a processor and a memory, a plurality of IP addressable devices, and a machine-readable storage medium encoded with a computer program code such that, when the computer program code is executed by a processor, the processor performs a method comprising:
identifying at least first and second devices associated with a network as having a same IP address;
determining a first IP address in an IP address range as being free for allocation to one of the first and second devices;
adding an entry to an address resolution protocol (ARP) table to route TCP/IP commands to the first or second device;
correlating an original IP address of the first or second to a media access control (MAC) address of that device;
sending a command to change the IP address of the first or second device to the first IP address;
reclassifying the first IP address as no longer being free for allocation; and
clearing the entry in the ARP table so that so that TCP/IP commands can be routed to other conflicting devices.

13. The system of claim 12, wherein the determining step comprises checking the first IP address against a list of IP addresses of devices known to be present on the network.

14. The system of claim 12, comprising verifying that the first address is free using a network scanning mechanism.

15. The system of claim 14, wherein the network scanning mechanism comprises a ping or a portmap.

16. The system of claim 12, wherein at least one of the plurality of devices comprises a video camera.

17. The system of claim 12, wherein when the first IP address is determined to be unavailable, selecting a next IP address and determining whether the next IP address is free for allocation.

18. The system of claim 12, wherein the IP address range is a user-defined.

19. The system of claim 18, wherein the command to change the IP address of the first or second device sending comprises a TCP/IP command.

20. The system of claim 12, comprising determining whether a second targeted device exists in a list of devices to be cleared of conflicting IP addresses; and repeating said determining, adding, correlating, sending and reclassifying steps for a second targeted device of said list of devices.

21. The system of claim 12, wherein if the first IP address is determined to be not free, determining whether a next IP address is free.

22. The system of claim 21, comprising repeating the determining step until a free address is identified.

23. A system for resolving conflicts in IP addresses for a plurality of devices on a network, the system comprising
a controller, comprising a processor, a memory, an address resolution protocol (ARP) table, a network interface, and a user interface;
the controller configured to:
identify first and second devices associated with a network as having a same IP address;
allocate a free IP address for allocation to a selected one of the first and second devices;
add an entry to the ARP table to route TCP/IP commands to the selected device;
command the selected device to change its IP address to the free IP address;
reclassify the first IP address as no longer being free for allocation; and
clearing the entry in the ARP table so that so that TCP/IP commands can be routed to other conflicting devices.
